(19) United States
(12) Patent Application Publication
(10) Pub. No.: US 2026/0057273 A1
(43) Pub. Date: Feb. 26, 2026

(54) CONTROL SYSTEM FOR A QUANTUM COMPUTER

(71) Applicant: Rohde & Schwarz GmbH & Co. KG, Muenchen (DE)

(72) Inventor: Christoph RUEHLE, Zurich (CH)

(21) Appl. No.: 18/777,966

(22) Filed: Jul. 19, 2024

(51) Int. Cl. G06N 10/40

(52) U.S. Cl. CPC G06N 10/40

(57) ABSTRACT

Embodiments of the present disclosure relate to a control system for a quantum computer. The control system is a quantum computing control system. The control system includes a plurality of arbitrary waveform generators for controlling qubits. The control system includes at least one quantum measurement device for reading out qubit states. The control system further includes a sequencer configured to control the plurality of arbitrary waveform generators.

### FIELD OF THE DISCLOSURE

Embodiments of the present disclosure relate to a control system for a quantum computer.

### BACKGROUND

Quantum computing is becoming more popular nowadays as the computing time required for solving mathematical and/or physical problems can be significantly reduced compared to conventional computer systems. Quantum computing is based on quantum bits (qubits), which serve the same function as bits in classical computing. Contrary to the classical bit having two defined states, e.g. “0” and “1”, a qubit may also exist in a superposition, namely in addition to its two states “|0>” and “|1>” being the quantum-mechanical counterparts of the classic states “0” and “1”. In other words, when measuring the qubit, the result is a probabilistic output of a classical bit. When a qubit is measured in the standard basis, the result of the measurement corresponds to the one of a classical bit.

Quantum computing also has drawbacks since the unstable nature of quantum information makes it prone to errors. Therefore, quantum error correction is necessary. Most prominent candidates for quantum error correction are surface codes due to their two-dimensional architecture as, inter alia, described in “Review on the decoding algorithms for surface codes” by deMarti iOlius et al, the disclosure of which is hereby incorporated by reference in its entirety.

Currently, surface code decoders for stabilizing single memory logical qubits can be implemented in a programmable quantum system controller (PQSC). More complex operations on logical qubits are however not possible, as a lattice surgery is not possible. According to lattice surgery, the internal sequencers of the arbitrary waveform generators (AWGs), also called arbitrary waveform generator sequencers, have to be coordinated so as to jump into different sub-programs that enable or disable surface code cycles on certain qubit patches on a qubit chip. For a user of a quantum computer, the known approaches however are extremely complicated if not impossible.

Accordingly, there is a need for a possibility to execute operations on logical qubits that involve branching into different AWG sub-programs in an easy and simple manner to be executable by a user of a quantum computer.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure relate to a control system for a quantum computer. The control system is a quantum computing control system. In an embodiment, the control system comprises a plurality of arbitrary waveform generators comprising circuitry for controlling qubits. The control system comprises at least one quantum measurement device comprising circuitry for reading out qubit states. The control system further comprises a sequencer comprising circuitry configured to control the plurality of arbitrary waveform generators.

The main idea is to provide an easy coordination of multiple arbitrary waveform generators (AWGs) and their branching into sub-programs by the sequencer that controls the AWGs accordingly. The sequencer is separately formed with regard to the AWGs. Since the plurality of AWGs is controlled by the (separately formed) sequencer, the sequencer is a high-level sequencer, e.g. when compared to the AWGs. Put differently, the sequencer is ranked higher than the AWGs.

This concept also ensures an easier implementation of logical qubit operations, for example in an error-detecting surface code.

As a result of embodiments of the present disclosure, a user of the quantum computer controlled by the control system can easily control the plurality of AWGs without the need to manually coordinate synchronization and control logic among the AWGs. In an embodiment, circuitry of the sequencer can be implemented on at least one central processing unit (CPU), for instance an embedded CPU, that controls the plurality AWGs associated with individual qubits, respectively.

In an embodiment, the at least one quantum measurement device reads out the qubit states of the qubits, wherein the respective information about the qubit state may be provided to the sequencer that processes the information for controlling the AWGs. Hence, a conditional controlling of the AWGs may take place accordingly.

An aspect provides that the sequencer is configured, for example, to cause the arbitrary waveform generators to generate pulse sequences for controlling groups of qubits. The single sequencer is thus enabled to (indirectly) control several qubits via the group of AWGs that is directly controlled by the sequencer. The controlling of the group of AWGs may be take place based on message links outputted by the sequencer. The AWGs internally process the message links received for controlling the respective qubits.

Generally, an unambiguous assignment of the AWGs to the qubits may be provided. Hence, the sequencer controlling the AWGs indirectly controls the qubits associated with the AWGs.

According to a further aspect, the control system further comprises, for example, a plurality of quantum measurement devices for reading out qubit states. The quantum measurement devices may also be unambiguously assigned to the qubits such that each qubit has a dedicated quantum measurement device via which the respective qubit state can be read out. The qubit state read out can be forwarded to the sequencer for being processed. Therefore, a conditional controlling of the AWGs and, thus a conditional branching into sub-programs may be done.

In an embodiment, circuitry of the sequencer may be configured to receive measurement outcomes from the at least one quantum measurement device. As indicated above, the information of the qubit states, namely the measurement outcomes, may be forwarded to the sequencer via the at least one quantum measurement device such that the sequencer is enabled to perform the controlling based on the measurement outcomes.

For instance, the sequencer includes circuitry configured to control the at least one quantum measurement device. The sequencer may also include circuitry configured to control the at least one quantum measurement device, thereby causing the at least one quantum measurement device to determine the qubit state. In other words, the sequencer may define the qubit read-outs via the at least one quantum measurement device, namely the respective times.

Another aspect provides that the sequencer is configured, for example, to control at least one group of arbitrary waveform generators as a whole. The group of AWGs may be controlled commonly via the sequencer rather than individually, which simplifies the overall controlling significantly. The sequencer may also control the group of AWGs simultaneously.

In an embodiment, the sequencer is configured such that the assignment of the arbitrary waveform generators to the at least one group is adaptable. Hence, the group of AWGs is dynamic or flexible, as the respective assignment of the AWGs to the group can be adapted for controlling purposes. The (re-)assignment of the AWGs to the group may depend on the measurement outcomes from the at least one quantum measurement device, e.g. the qubit states measured.

Moreover, the sequencer comprises a memory which encompasses at least one template table, and wherein the sequencer is configured to control at least one group of arbitrary waveform generators based on the at least one template table. The memory may comprise several template tables for different controlling purposes. Alternatively or additionally, the at least one template table is adapted by the sequencer for controlling the AWGs. In an embodiment, the respective template table may be selected out of a group of template tables depending on the measurement outcomes from the at least one quantum measurement device, e.g. the qubit states measured. Alternatively or additionally, the at least one template table is adapted by the sequencer based on the measurement outcomes from the at least one quantum measurement device, e.g. the qubit states measured. Therefore, a conditional controlling of the AWGs is realized.

In an embodiment, the at least one quantum measurement device is configured to cause the sequencer to output message links for the arbitrary waveform generators according to a specific template table. The message links are processed by the AWGs to control the qubits, e.g. convert the message links into qubit control signals to be forwarded by the respective AWG to the qubit associated therewith.

For instance, the at least one quantum measurement device is configured to cause the sequencer to output the message links for the arbitrary waveform generators according to the specific template table based on a measurement outcome of the at least one quantum measurement device. Accordingly, the measurement outcome of the at least one quantum measurement device is received and processed by the sequencer that in turn selects the specific template table or adapts a template table so as to obtain the specific template table based on which the AWGs are controlled accordingly via the message links. The message links received by the AWGs are internally processed by the AWGs so as to obtain the qubit control signals for controlling the associated qubits, respectively.

Another aspect provides that the control system further comprises, for example, a surface code decoder including circuitry configured to correct a measurement outcome of the at least one quantum measurement device. The surface code decoder is an optional module that is connected with the at least one quantum measurement device. The surface code decoder receives the measurement outcome and provides a corrected measurement outcome.

In an embodiment, the surface code decoder includes circuitry configured to provide a corrected measurement outcome to the sequencer. Hence, the surface code decoder is interconnected between the at least one quantum measurement device and the sequencer so as to receive the measurement outcome and provide the corrected measurement outcome that is forwarded to the sequencer for being processed. In an embodiment, the sequencer may control the AWGs inter alia based on the corrected measurement outcome provided by the surface code decoder. Hence, the sequencer is configured to select a specific template table inter alia depending on the corrected measurement outcome.

For instance, the sequencer is configured to provide a specific template table depending on a measurement outcome of the at least one quantum measurement device and the corrected measurement outcome from the surface code decoder. In an embodiment, the sequencer takes both the corrected measurement outcome provided by the surface code decoder and the (raw) measurement outcome provided by the at least one quantum measurement device into account for providing the specific template table based on which the AWGs are controlled. As indicated above, the specific template table may be selected or a template table may be adapted so as to obtain the specific template table.

In an embodiment, each of the plurality of arbitrary waveform generators may comprise a generator sequencer, a waveform memory and/or an instruction memory. The generator sequencer relates to an internal sequencer of the AWG. The generator sequencer receives and processes the message link received from the sequencer.

In an embodiment, the waveform memory provides a waveform to be used for controlling the qubit, e.g. for generating the qubit control signal.

In an embodiment, the instruction memory may comprise sub-programs to be executed, for instance a surface code stabilizer cycle, a qubit initialization and/or a qubit readout.

In an embodiment, the generator sequencer receives or reads out information from the waveform memory and the instruction memory when processing the message link received in order to output the qubit control signal.

A further aspect provides that the sequencer is configured, for example, to perform real-time controlling of the plurality of arbitrary waveform generators. Since several AWGs, e.g. the group of AWGs, can be controlled by the sequencer, the sequencer is also enabled to perform a real-time controlling.

In an embodiment, the sequencer may be configured to cause the plurality of arbitrary waveform generators to output qubit control signals for controlling qubits. As indicated above, the sequencer indirectly controls the qubits assigned to the AWGs by controlling the AWGs.

Embodiments of the present disclosure also relate to a control system for a quantum computer. The control system is a quantum computing control system. In an embodiment, the control system comprises at least one arbitrary waveform generator comprising circuitry for controlling qubits. The control system comprises a plurality of quantum measurement devices comprising circuitry for reading out qubit states. The control system further comprises a sequencer comprising circuitry configured to read out the plurality of quantum measurement devices. Hence, the sequencer may also read out the plurality of quantum measurement devices, e.g. the measurement outcomes of the plurality of quantum measurement devices, namely the qubit states. Based on the qubit states or the measurement outcomes, the sequencer is enabled to control the at least one AWG. Thus, a conditional controlling of the at least one AWG is enabled.

In an embodiment, the control system for the quantum computer may further comprise a plurality of AWGs that are controlled by the sequencer, for example in a conditional manner based on the qubit states read out.

Embodiments of the present disclosure also relate to a quantum computing system that comprises a quantum computer and the control system described above, wherein the quantum computer has qubits that are controlled by the control system, particularly as described above.

Consequently, a simple and easy controlling of a quantum computer is achieved, which can be performed by a user of the quantum computer.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of a quantum computing system with a quantum computer and a control system according to an embodiment of the present disclosure, and

FIG. 2 schematically shows an overview illustrating the controlling of a quantum computer by a control system according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

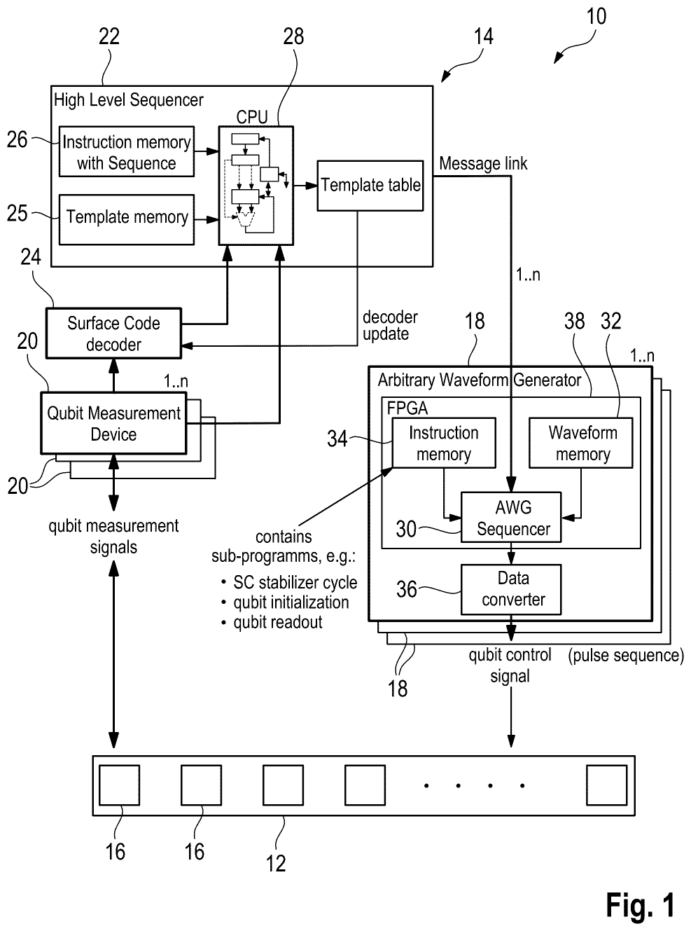

In FIG. 1, a quantum computing system 10 is shown that comprises a quantum computer 12 as well as a control system 14 for the quantum computer 12. Accordingly, the control system 14 relates to a quantum computing control system since the control system 14 controls the quantum computer 12, for example the qubits 16 of the quantum computer 12. In the shown embodiment, the control system 14 comprises a plurality of arbitrary waveform generators (AWGs) 18, namely 1 to n arbitrary waveform generators 18, which are assigned to the qubits 16 of the quantum computer 12. The control system 14 further comprises a plurality of quantum measurement devices 20, namely 1 to n quantum measurement devices 20, which read out qubit states of the qubits 16 of the quantum computer 12. In an embodiment, the quantum measurement devices 20 perform measurements on the qubits 16, thereby gathering measurement outcomes.

Generally, the control system 14 may comprise at least one arbitrary waveform generator 18 and the plurality of quantum measurement devices 20, the plurality of arbitrary waveform generators 18 and at least one quantum measurement device 20 or the plurality of arbitrary waveform generators 18 and the plurality of quantum measurement devices 20, the latter one is shown in FIG. 1.

In the embodiment of FIG. 1, the control system 14 includes a sequencer 22 that is connected with the plurality of quantum measurement devices 20 as well as the plurality of arbitrary waveform generators 18. In an embodiment, the sequencer 22 is used to control the plurality of arbitrary waveform generators 18 as will be described hereinafter in more detail and, therefore, the sequencer 22 relates to a high level sequencer, as it is ranked higher than the plurality of arbitrary waveform generators 18. The measurement outcomes of the at least one quantum measurement device 20 are forwarded to the sequencer 22 such that the sequencer 22 may perform a conditional controlling of the arbitrary waveform generators 18.

Besides the plurality of arbitrary waveform generators 18, the plurality of quantum measurement devices 20 as well as the sequencer 22 separately formed with respect to the arbitrary waveform generators 18 and the quantum measurement devices 20, the control system 14 may also comprise a separately formed (optional) surface code decoder 24.

In an embodiment, the optional surface code decoder 24 is interconnected between the at least one quantum measurement device 20 and the sequencer 22 while being enabled to correct a measurement outcome of the at least one quantum measurement device 20. The corrected measurement outcome obtained by the surface code decoder 24 can be forwarded to the sequencer 22 which takes the corrected measurement outcome (also) into account when conditionally controlling the arbitrary waveform generators 18. Hence, the sequencer 22 may take both the corrected measurement outcome provided by the surface code decoder 24 as well as the (raw) measurement outcome of the at least one quantum measurement device 20 into account when controlling the arbitrary waveform generators 18.

As shown in FIG. 1, the sequencer 22 comprises a template memory 25, an instruction memory 26, and processor circuitry, such as at least one central processing unit (CPU) 28. The sequencer 22, for example its CPU 28, is enabled (e.g., programmed, etc.) to receive and process the information received from the at least one quantum measurement device 20 and, optionally, the surface code decoder 24.

Moreover, the CPU 28 is enabled (e.g., programmed, etc.) to access the template memory 25 and the instruction memory 26 so as to obtain a specific template table for controlling the arbitrary waveform generators 18. The specific template table may be selected by the CPU 28 from a group of template tables encompassed in the template memory 25, for example based on the information obtained, namely the measurement outcome and, optionally, the corrected measurement outcome. Alternatively or additionally, a (generic) template table may be adapted by the CPU 28 so as to generate the specific template table used for controlling the arbitrary waveform generators 18. Again, the adaption of the (generic) template table may be based on the information obtained, namely the measurement outcome and, optionally, the corrected measurement outcome.

Once the specific template table used for controlling the arbitrary waveform generators 18 is obtained, e.g. selected or adapted, the information about the specific template table may be forwarded by the sequencer 22 to the surface code decoder 24 in order to update the decoder accordingly with regard to the controlling of the arbitrary waveform generators 18. This enables the surface code decoder 24 to correct the upcoming measurement outcomes of the at least one quantum measurement device 20.

The sequencer 22 outputs a message link to the at least one arbitrary waveform generator 18 for controlling the at least one arbitrary waveform generator 18 accordingly, namely based on the at least one template table, for example the specific template table. In an embodiment, up to n message links are outputted by the sequencer 22 in case of n arbitrary waveform generators 18 (to be controlled).

In an embodiment, the arbitrary waveform generators 18 each have an internal AWG sequencer 30 that receives the message links from the sequencer 22. The arbitrary waveform generators 18 also have a waveform memory 32 as well as an AWG instruction memory 34 that contains sub-programs to be performed by the respective AWG 18, e.g. a surface code, SC, stabilizer cycle, a qubit initialization and/or a qubit readout.

The internal AWG sequencer 30 reads out the waveform memory 32 as well as an AWG instruction memory 34 in order to generate a qubit control signal based on the message link received from the sequencer 22. In an embodiment, the internal AWG sequencer 30 reads out the memories 32, 34 of the respective AWG while processing the message link received from the sequencer 22.

Each of the AWGs 18 further comprises a data converter 36 that processes the output of the internal AWG sequencer 30 in order to generate the qubit control signal forwarded to the respective qubit 16 of the quantum computer 12. The qubit control signal may relate to a pulse sequence that has a shape based on information derived from the waveform memory 32.

In the embodiment shown in FIG. 1, the internal AWG sequencer 30, the waveform memory 32 as well as the AWG instruction memory 34 may be implemented commonly on a field-programmable gate array (FPGA) 38.

The main advantage of the separately formed sequencer 22, which is a high level sequencer, is that several arbitrary waveform generators 18 can be controlled, e.g. by the specific template table. In an embodiment, a group of arbitrary waveform generators 18 may be controlled by the sequencer 20, wherein the group relates to a subset of the plurality of arbitrary waveform generators 18, for instance m arbitrary waveform generators 18 of the n arbitrary waveform generators 18, wherein m is smaller than n. The group of the arbitrary waveform generators 18 may be controlled by the sequencer 22 as a whole, namely commonly.

The assignment of the arbitrary waveform generators 18 to the at least one group is adaptable such that the commonly controlled arbitrary waveform generators 18 may be adapted, for instance depending on the information received by the sequencer 22. As indicated above, the sequencer 22 may take the qubit states (measurement outcomes) provided by the at least one quantum measurement device 20 and, optionally, the corrected measurement outcomes into account for controlling the arbitrary waveform generators 18.

Hence, depending on the (corrected) measurement outcome the group of arbitrary waveform generators 18 to be controlled as a whole may be adapted. Thus, a conditional controlling of the arbitrary waveform generators 18 is established.

As indicated above, the specific template table is used for controlling the arbitrary waveform generators 18, namely the group of arbitrary waveform generators 18 to be controlled as a whole. The specific template table is obtained, e.g. obtained by adapting a (generic) template table or selecting the specific template table out of several template tables, based on which the message links for the arbitrary waveform generators 18 are obtained. Consequently, the at least one quantum measurement device 20 causes the sequencer 22 to output the message links for the arbitrary waveform generators 18 according to the specific template table. In an embodiment, the at least one quantum measurement device 20 causes the sequencer 22 to output the message links for the arbitrary waveform generators 18 according to the specific template table based on the measurement outcome of the at least one quantum measurement device 20 and, optionally, the corrected measurement outcome obtained by the surface code decoder 24.

In an embodiment, the sequencer 22 may not only read out the at least one quantum measurement device 20, but the sequencer 22 may also control the at least one quantum measurement device 20, e.g. to cause the at least one quantum measurement device 20 to perform a measurement on the respective qubit 16.

In an embodiment, the controlling of the arbitrary waveform generators 18 may be done by the sequencer 22 in real-time.

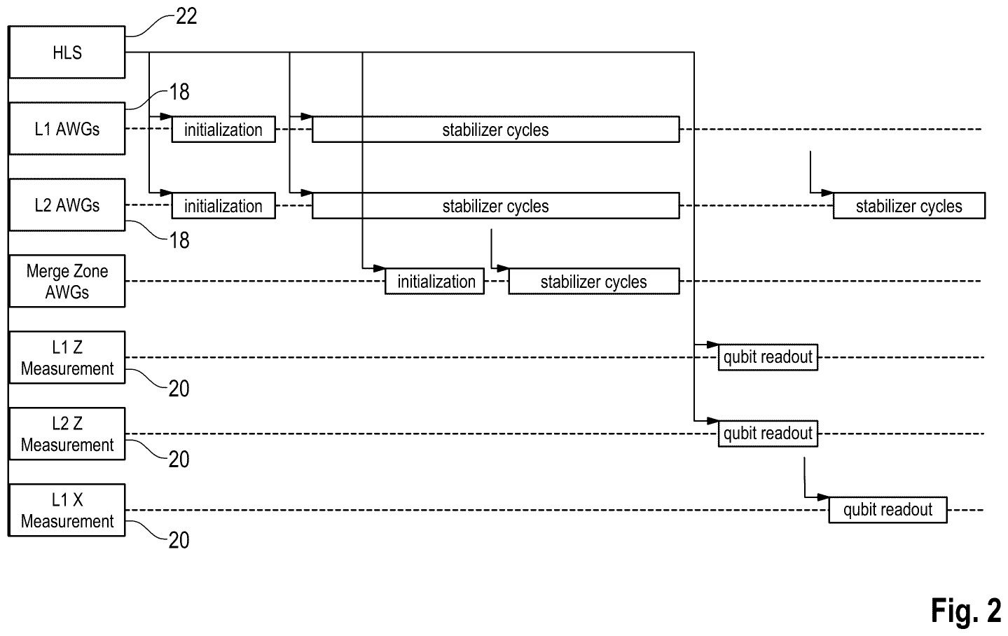

As shown in FIG. 2, the sequencer 22, namely the high level sequencer, HLS, controls the AWGs 18 and the quantum measurement devices 20, for example the respective sub-programs, e.g. qubit initializations, stabilizer cycles as well as qubit readouts.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,”etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the quantum computer 12, the control system 14, the arbitrary waveform generators 18, the quantum measurement devices 20, the surface code decoder 24, etc., referenced above include circuitry programmed to carry out the functionality of the system 10 disclosed herein. In an embodiment, one or more computer-readable media associated with or accessible by such circuitry contains computer readable instructions embodied thereon that, when executed by such circuitry, cause the component or circuity to perform some or all of functionality disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B. ”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A control system for a quantum computer, wherein the control system is a quantum computing control system and comprises: a plurality of arbitrary waveform generators including circuitry for controlling qubits; at least one quantum measurement device including circuitry for reading out qubit states; and a sequencer including circuitry configured to control the plurality of arbitrary waveform generators.

2. The control system according to claim 1, wherein the sequencer is configured to cause the arbitrary waveform generators to generate pulse sequences for controlling groups of qubits.

3. The control system according to claim 1, further comprising a plurality of quantum measurement devices for reading out qubit states.

4. The control system according to claim 1, wherein the sequencer is configured to receive measurement outcomes from the at least one quantum measurement device.

5. The control system according to claim 1, wherein the sequencer is configured to control the at least one quantum measurement device.

6. The control system according to claim 1, wherein the sequencer is configured to control at least one group of arbitrary waveform generators as a whole.

7. The control system according to claim 6, wherein the sequencer is configured such that the assignment of the arbitrary waveform generators to the at least one group is adaptable.

8. The control system according to claim 1, wherein the sequencer comprises a memory which encompasses at least one template table, and wherein the sequencer is configured to control at least one group of arbitrary waveform generators based on the at least one template table.

9. The control system according to claim 8, wherein the at least one quantum measurement device is configured to cause the sequencer to output message links for the arbitrary waveform generators according to a specific template table.

10. The control system according to claim 9, wherein the at least one quantum measurement device is configured to cause the sequencer to output the message links for the arbitrary waveform generators according to the specific template table based on a measurement outcome of the at least one quantum measurement device.

11. The control system according to claim 1, further comprising a surface code decoder configured to correct a measurement outcome of the at least one quantum measurement device.

12. The control system according to claim 11, wherein the surface code decoder is configured to provide a corrected measurement outcome to the sequencer.

13. The control system according to claim 12, wherein the sequencer is configured to provide a specific template table depending on a measurement outcome of the at least one quantum measurement device and the corrected measurement outcome from the surface code decoder.

14. The control system according to claim 1, wherein each of the plurality of arbitrary waveform generators comprises a generator sequencer, a waveform memory and/or an instruction memory.

15. The control system according to claim 1, wherein the sequencer is configured to perform real-time controlling of the plurality of arbitrary waveform generators.

16. The control system according to claim 1, wherein the sequencer is configured to cause the plurality of arbitrary waveform generators to output qubit control signals for controlling qubits.

17. A control system for a quantum computer, wherein the control system is a quantum computing control system, wherein the control system comprises: at least one arbitrary waveform generator for controlling qubits; a plurality of quantum measurement devices for reading out qubit states; and a sequencer configured to read out the plurality of quantum measurement devices.
